(19) United States
(12) Patent Application Publication
(10) Pub. No.: US 2007/0223443 A1
(43) Pub. Date: Sep. 27, 2007

(54) Transmission of Asset Information in Streaming Services

(76) Inventors: Ye-Kui Wang, Tampere (FI); Emre Baris Aksu, Tampere (FI)

Correspondence Address: WARE FRESSOLA VAN DER SLUYS &;ADOLPHSON, LLP, BRADFORD GREEN, BUILDING 5, 755 MAIN STREET, P O BOX 224, MONROE, CT, 06468, US

(21) Appl. No.: 10/589,107

(22) PCT Filed: Feb. 12, 2004
(86) PCT No.: PCT/IB04/00358

§ 371 Date: Apr. 13, 2007

(51) Int. Cl. H04L 29/06

(52) U.S. Cl. 370/349

(57) ABSTRACT

This invention relates to a method, a computer program product, devices, a system and a session description protocol for transferring data (101, 106) and information on associated data asset information, comprising providing (307) session description information (110) that at least partially contains the information on the data asset information, wherein the session description information (110) obeys a first protocol, transferring (309) the session description information (110) to a destination instance (301) based on a second protocol (107, 109, 102), and transferring (313) the data (101, 106) between a source instance (305) and the destination instance (301) within a transfer session and based on a third protocol (102). The first, second (107, 109, 102) and third (102) protocols are preferably the Session Description, Real-time Streaming and Real-time Transport Protocol in a 3G Packet-Switched Streaming Services context.

### FIELD OF THE INVENTION

This invention relates to a method, a computer program, a computer program product, a system, devices and a protocol for transferring data and information on associated data asset information.

### BACKGROUND OF THE INVENTION

Streaming refers to the ability of an application settled in a client to play synchronized media streams like audio and video streams in a continuous way while those streams are being transmitted to the client over a data network.

Applications that can be built on top of streaming services can be classified into on-demand and live information delivery applications. Examples of the first category are music and news-on-demand applications. Live delivery of radio and television programs are examples of the second category.

Streaming over fixed Internet Protocol (IP) networks is already a major application today. While the Internet Engineering Task Force (IETF) and the World Wide Web Consortium (W3C) have developed a set of protocols used in fixed-IP streaming services, no complete standardized streaming framework has yet been defined. For Third Generation (3G) mobile communications systems according to the standards developed by the Third Generation Partnership Project (3GPP), the 3G Packet-switched Streaming Service (PSS, 3GPP TS 26.233, TS 26.234) fills the gap between the 3G Multi-media Messaging Service (MMS), for instance downloading applications and multimedia content, and conversational & streaming services.

The PSS enables mobile streaming applications, wherein the complexity of the terminals is lower than that required for conversational services, because no media input devices and encoders are required, and because less complex protocols can be used. The PSS includes a basic set of streaming control protocols, transport protocols, media codecs and scene description protocols.

FIG. 1 schematically depicts the PSS protocol stack 1 that controls the transfer of both streamable and non-streamable content between a content or media server and a client.

Streamable content 101, such as video, audio and speech, is first converted to the payload format of the Real-time Transport Protocol (RTP) 102 in an adaptation layer 103. Said RTP as defined by the IETF provides means for sending real-time or streaming data by using the services of an underlying User Datagram Protocol (UDP) 104, which in turn uses the services of an underlying IP protocol 105.

Non-streamable content 106, as for instance multimedia content which is not created for streaming purposes (e.g. MMS clips recorded on a terminal device), still images, bitmap and vector graphics, text, timed text and synthetic audio are transferred by the Hypertext Transfer Protocol (HTTP) 107, which uses the services of the underlying Transport Control Protocol (TCP) 108 and the further underlying IP 105.

Whereas for the non-streamable content 106, the built-in session set-up and control capabilities of the HTTP 107 are sufficient to transfer the content, in case of streamable content 101, an advanced session set-up and control protocol has to be invoked, for instance to start, stop and pause a streaming video that is transferred from the content server to the client via the RTP/UDP/IP. This task is performed by the Real-time Streaming Protocol (RTSP) 109, which may either use the underlying TCP 108 or the underlying UDP 104. RTSP requires a presentation description 110 at least to set-up a streaming session. Such a presentation description 110 may for instance be available in the form of a Session Description Protocol (SDP) file. Said SDP file contains the description of the session, for instance session name and author, the type of media to be presented, information to receive said media, as for instance addresses, ports, formats and so on, and the bitrate of the media.

If streaming content is to be viewed at the client side, for instance at a mobile terminal, the user of said terminal is first provided with a Universal Resource Identifier (URI) to specific content that suits his terminal. This URI may come form a WWW server, a Wireless Application Protocol (WAP) server, or may have been entered manually via the keyboard of the terminal. This URI specifies a streaming or RTSP server and the address of the content on that or another content server. The corresponding SDP file may now be obtained in a number of ways. It may be provided in a link inside the HTML page that the user downloads, for instance via an embed tag, or may also be directly obtained by typing it as a URI.

The SDP file, i.e. the presentation description 110, then is transferred via the HTTP 107 as indicated in the middle column of the protocol stack of FIG. 1.

Alternatively, it may also be obtained through RTSP 109 signalling, for instance by using the DESCRIBE method of the RTSP 109, as indicated by the right column of the protocol stack in FIG. 1. Note that the presentation description may equally well be transmitted by said RTP 102. However, for simplicity of presentation, this possibility was not included in FIG. 1.

The subsequent session establishment is the process in which the browser or the user of the mobile terminal invokes a streaming client to set up the session against the content server. The terminal is expected to have an active radio bearer that enables IP-based packet transmission at the start of session establishment signalling.

The subsequent set-up of the streaming service is done by sending an RTSP SETUP message for each media stream chosen by the client. This returns the UDP 104 and/or TCP 108 port to be used for the respective media stream. The client sends an RTSP PLAY message to the content server that then starts to send one or more streams over the IP network.

Within the PSS, the file format is an important element of the content manipulation chain. Conceptually, there is a difference between the coding format and the file format. The coding format is related to the action of a specific coding algorithm that codes the content information into a code stream. The file format is instead a way of organising the pre-stored code stream in such a way that it can be accessed for local decoding and playback, or transferred as a file on different media, or streamed over different transport channels. Some file formats are optimised for one or more of these functions, others aim instead at achieving higher flexibility. In the PPS and in the Multimedia Messaging Service (MMS), the 3GPP File Format (3GP) is used. It is structurally based on the International Standardisation Organisation (ISO) base media file format (ISO/IEC 14496-12:2004) and mandated to be used for continuous media along the entire delivery chain, independent whether the final delivery is done by download or streaming, thus enabling interoperability. Whereas in the first case, a self-contained file (i.e. there are no external media data referenced by the file) is transferred, in the second case, the content is extracted from the 3GP file and streamed according to IETF-defined payload formats.

The 3GP file format can contain timing, structure and media data for multimedia streams. The file format is organised in boxes, wherein a movie, track, media, media information, sample table and sample description box are differentiated. Within the movie box or the track box, a User Data Box (udta) may be present. Within said udta, there may reside sub-boxes that contain asset meta-data, which can be categorised into ten kinds of information:
title: title for the media,
description: caption or description for the media,
copyright: notice about organisation holding the copyright for the media file,
performer: performer or artist,
author: author of the media,
genre: genre (category or style) of the media,
rating: media rating,
classification: classification of the media,
keywords: media keywords, and
location: location information.

These information are currently defined by 3GPP PSS, and there may be more asset sub-boxes defined in the future.

When content is streamed from a content server to a client within the PSS, the 3GP file format is not sent as it is, but the media data content contained in the 3GP file format is streamed to the client according to IETF-defined payload formats, as indicated by the adaptation layer 103 of the protocol stack of FIG. 1. However, the PSS does not provide a mechanism to transfer the asset meta-data that is contained in the 3GP file format at the content server to the client. The presence of said asset-meta data is simply ignored in streaming applications.

### SUMMARY OF THE INVENTION

In view of the above-mentioned problem, it is, inter alia, an object of the present invention to provide a method, a computer program, a computer program product, devices, a system and a protocol for transferring data and information on associated data asset information.

It is proposed a method for transferring data and information on associated data asset information, comprising the steps of providing session description information that at least partially contains said information on said data asset information, wherein said session description information obeys a first protocol, transferring said session description information to a destination instance based on a second protocol, and transferring said data between a source instance and said destination instance within a transfer session and based on a third protocol.

Said source instance may for instance be a content server and said destination instance may be a client in a wired or wireless media distribution system, for instance a content server and a client in the context of a 3G PSS. Accordingly, said data may represent media content such as video, audio, images, text, speech, etc. Said content may be streamable or non-streamable.

Said data asset information may comprise media-level information characterising the media content itself, for instance title, description, copyright, performer, author, genre, rating, classification, keywords and/or location of the medium, as may for instance be defined in the User Data Box in the Movie Box or Track Box of a 3GP file container. In particular, said data asset information may be characterised as all kinds of information that may be of interest for a user when rendering or playing back said data, but that may technically not be required to render the data.

Said data and said data asset information do not necessarily have to be stored at the same location or in the same device.

In order to be able to transfer information on said data asset information, said information on said data asset information may be integrated in session description information. Said information on said data asset information may for instance be a part of or the complete data asset information, or a reference or a pointer to a location from which a part of or the complete data asset information may be retrieved, as for instance a URL pointer. If said data and said information on said data asset information jointly obey the same pre-defined format, said information on said data asset information may be extracted from said pre-defined format before integration into said session description information is possible. Similarly, if said information on said data asset information obeys a different pre-defined format than said data, said information on said data asset information may be extracted from its own pre-defined format before said integration. Said information on said data asset information then may be integrated into said session description information.

Said session description information obeys said first protocol, for instance an SDP, and may provide said destination instance with information to establish a streaming data session with said source instance. Said information may for instance declare the media type of said data. Said first protocol may be extended or adapted to incorporate said information on said data asset information. Said session description information may be provided at said source instance or at an additional instance, e.g. at a presentation or RTSP server.

Said session description information is transferred between said source instance or said additional instance and said destination instance based on a second protocol, for instance an RTSP, an HTTP or an RTP. In case of an RTSP, said additional instance may for instance be an RTSP server. Based on said session description information, a user of said destination instance may decide whether a session in which said data is transferred between said source instance and destination instance is to be started or not. Said decision may for instance be based on said data asset information. Said session description information may be transferred in the header and/or payload section of protocol data units of said second protocol.

Said transfer of said data between said source and destination instance is based on a third protocol, for instance an RTP, and takes place within a transfer session. Within said transfer session, several data streams may be transferred between said source instance and said destination instance. Furthermore, data transfers from said source instance to several destination instances and from several source instances to one destination instance may take place.

According to the method of the present invention, it may be preferred that at least at said source instance (305), said data (101, 106) and said information on said data asset information jointly obey a pre-defined format. Both said data and said information on said data asset information may thus be jointly stored according to said pre-defined format, for instance a 3GPP file format. Said data and said information on said data asset information may obey said pre-defined file format also at said destination instance. According to the method of the present invention, it may be preferred that said data represents streamable content and that said transfer session is controlled by a Real-time Streaming Protocol RTSP. Said RTSP may allow a client to start, stop and/or pause said transfer session. Said RTSP may operate between said destination instance and an RTSP server which does not necessarily have to be co-located with said source instance.

According to the method of the present invention, it may be preferred that said second protocol is said RTSP. Said RTSP then allows for both the control of said transfer session and the transfer of said session description information. Said session description information then may be made available to said destination instance via said RTSP.

According to the method of the present invention, it may be preferred that said RTSP uses the services of a Transport Control Protocol TCP, a User Datagram Protocol UDP, or of a Hypertext Transfer Protocol HTTP.

According to the method of the present invention, it may be preferred that said session description information is transferred to said destination instance by using a DESCRIBE method of said RTSP. Alternatively, said session description information may be transferred by changing the header of protocol data units of said RTSP.

According to the method of the present invention, it may be preferred that said data represents streamable content, and that said second protocol is a HTTP. Said session description information may thus equally well be transferred by said HTTP instead of said RTSP.

According to the method of the present invention, it may be preferred that said HTTP uses the services of a TCP.

According to the method of the present invention, it may be preferred that said data represents streamable content, and that said second protocol is a Real-time Transport Protocol RTP.

According to the method of the present invention, it may be preferred that said third protocol is an RTP. Said data then is transferred within a transfer session via said RTP, wherein said transfer session itself may be controlled by said RTSP and may be described by said session description protocol.

According to the method of the present invention, it may be preferred that said RTP uses the services of a UDP.

According to the method of the present invention, it may be preferred that said TCP or UDP use the services of an Internet Protocol IP.

According to the method of the present invention, it may be preferred that said first protocol is a Session Description Protocol (SDP). Said session description information then may be represented by an SDP file.

According to the method of the present invention, it may be preferred that said session description information is a data structure with at least one pre-defined attribute structure for at least a part of said data asset information or for at least one reference to an actual location of at least a part of said data asset information. Said information on said data asset information thus may be either contained directly in an attribute structure, or be contained as a pointer, reference or link to a location where said data asset information can be found, for instance on a different server.

According to the method of the present invention, it may be preferred that said second and third protocols at least partially define a protocol stack for a Packet-switched Streaming Service PSS in a 3G mobile communications system.

According to the method of the present invention, it may be preferred that said pre-defined format is a 3GPP file format or any other file format.

According to the method of the present invention, it may be preferred that said data asset information is asset meta-data information contained in a User Data Box of a Movie Box or Track Box of a 3GP file container or any other file container, for instance title, description, copyright, performer, author, genre, rating, classification, keywords and/or location of the medium.

It is further proposed a computer program with instructions operable to cause a processor to perform the above-mentioned method steps.

It is further proposed a computer program product comprising a computer program with instructions operable to cause a processor to perform the above-mentioned method steps.

It is further proposed a system for transferring data and information on associated data asset information, the system comprising at least one source instance, and at least one destination instance, wherein session description information is provided that at least partially contains said information on said data asset information and that obeys a first protocol, wherein said session description information is transferred to said at least one destination instance based on a second protocol, and wherein said data is transferred between said at least one source instance and said at least one destination instance within a transfer session and based on a third protocol.

Said system may for instance conform to the PSS of a mobile communications system according to the 3GPP standard.

It is further proposed a device for transferring information on data asset information that is associated with data that is transferred between a source instance and a destination instance based on a first protocol, the device comprising means for providing session description information that at least partially contains said information on said data asset information, wherein said session description information obeys a second protocol, and means for transferring said session description information to a destination instance based on a third protocol.

Said device may for instance be a presentation server in a system that conforms to the PSS of a mobile communications system according to the 3GPP standard, in particular an RTSP server, or a part thereof.

It is further proposed a device for receiving data and information on associated data asset information, wherein session description information is provided that at least partially contains said information on said data asset information and that obeys a first protocol, the device comprising means for receiving said session description information, which is transferred to a destination instance based on a second protocol, and means for receiving said data, which is transferred between a source instance and said destination instance within a transfer session and based on a third protocol.

Said device may for instance be a client in a system that conforms to the PSS of a mobile communications system according to the 3GPP standard, or a part thereof.

According to this device of the present invention, it may be advantageous that said device further comprises means for at least partially extracting said information on said data asset information from said received session description information. Said information on said data asset information, which may for instance be said data asset information as a whole or in parts, or a link to a location where said data asset information may be retrieved in parts or as a whole, may support a user of said device in deciding whether a subsequent transfer of said data within a transfer session is actually desired or not. Said data asset information may be displayed to said user via a user interface of said destination device.

It is further proposed a session description protocol to be used in a system for transferring data and information on associated data asset information, wherein said data is transferred between a source instance and a destination instance within a transfer session and based on a first protocol, the session description protocol comprising a definition of a session description information that at least partially contains said information on said data asset information and that lends itself for transfer between said source instance and said destination instance based on a second protocol.

Said session description protocol may conform to the SDP that is used in the PSS of a mobile communications system according to the 3GPP standard. Said session description protocol may define a pre-defined attribute structure to incorporate information on said data asset information

These and other aspects of the invention will be apparent from and elucidated with reference to the embodiments described hereinafter.

### BRIEF DESCRIPTION OF THE FIGURES

In the figures show:

FIG. 1: A schematic representation of a Packet-Switched Streaming Service (PSS) protocol stack according to the prior art,

FIG. 2: an exemplary SDP attribute definition in

Augmented Backus-Naur Form according to the present invention,

FIG. 3: a schematic flowchart of the method according to the present invention,

FIG. 4: a schematic representation of the functional components of a first device according to the present invention, and

FIG. 5: a schematic representation of the functional components of a second device according to the present invention.

### DETAILED DESCRIPTION OF THE INVENTION

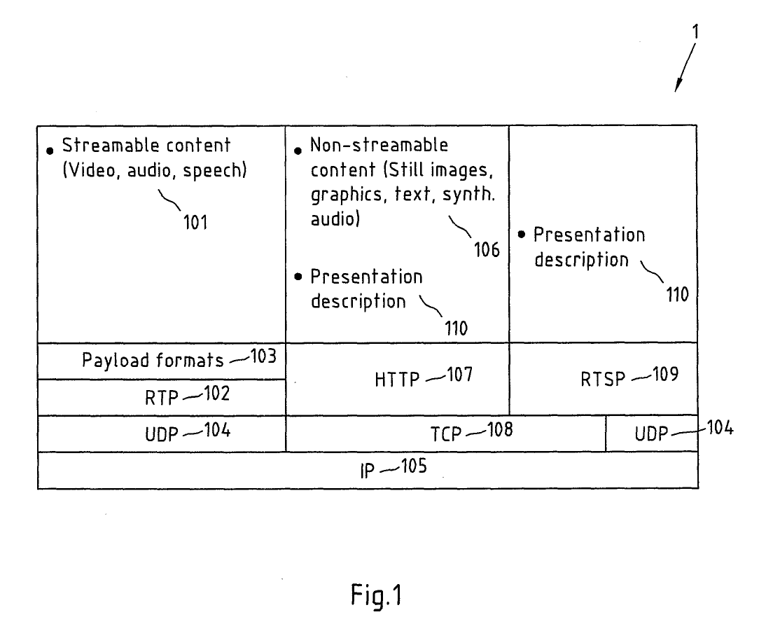

The protocol stack of a system that uses the Packet-Switched Streaming Service (PSS) with additional transfer of data asset information to a client according to the present invention is the same as the prior art protocol stack depicted in FIG. 1, because only the protocols itself, and in particular only the Session Description Protocol (SDP) and/or the Real-time Streaming Protocol (RTSP) are modified.

The present invention proposes to at least partially transfer information on data asset information to a client by at least partially incorporating data asset information or a reference pointing to at least parts of said data asset information into session description information that is transferred to said client anyway. Said session description information may be transferred based on a Hypertext Transfer Protocol (HTTP), a Real-time Transport Protocol (RTP) or based on a Real-time Streaming Protocol (RTSP). If said session description information is represented by a Session Description Protocol (SDP) file, a convenient way to incorporate information on said data asset information into said session description is to define a specific SDP attribute for the data asset information or for the reference or pointer to the data asset information.

Attributes are the primary means for extending SDP. Attributes may be either property attributes (“a=<flag>”), which are binary attributes, and the presence of the attribute then conveys the information that the attribute is a property of the session, or be value attributes. A value attribute is of the form “a=<attribute>:<value>”.

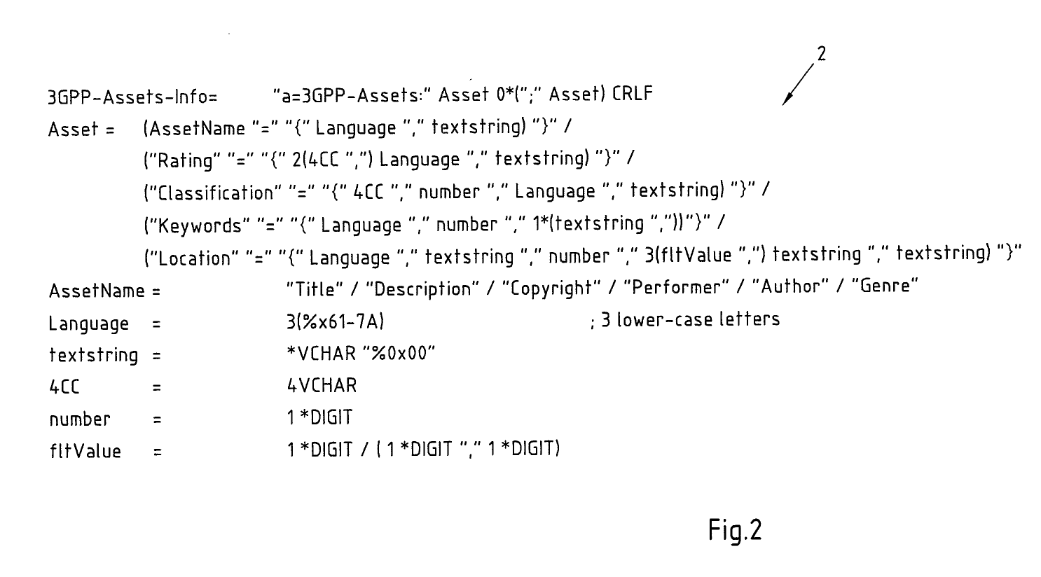

FIG. 2 presents an exemplary SDP value attribute definition 2 in Augmented Backus-Naur Form (ABNF) according to the present invention. This SDP attribute 2 conforms to the ABNF as defined in Internet Engineering Task Force (IETF) Request for Comments (RFC) document 2234. The “3GPP-Assets” attribute of FIG. 2 allows to assign asset information to the fields “Title”, “Description”, “Copyright”, “Performer”, “Author”, “Genre” “Rating”, “Classification”, “Keywords” and “Location”. Thus the information of the asset meta-data fields contained in the User Data Box (udta) that in turn is contained in a movie box or track box of a 3GP file container can be transferred as SDP value attributes to the client. To this end, the asset meta-data field is read from the 3GP file format and assigned to the desired SDP value attribute, for instance:
a=3GPP-Assets:Keywords={eng,3,hero,plane,superman};
or
a=3GPP-Assets:Location-{eng,Finland,0,25.0,63.5,Earth, Produced in Tampere).
or
a=3GPP-Assets:URL=<http:/www.assetslocator.fi/movie.3gp>

Whereas the first two examples indicate how actual data asset information is incorporated into an SDP file, in the last example, only a reference (a URL pointer) to a location where data asset information is provided is incorporated into an SDP file. In all three examples, thus information on data asset information is contained. Either one or more than one SDP line may be used for the assignment of asset meta-data fields to SDP attributes. The resulting SDP file containing all kinds of assigned session-level and media-level attributes then is transferred to the client via the RTSP. For the same purpose, also the HTTP could be used.

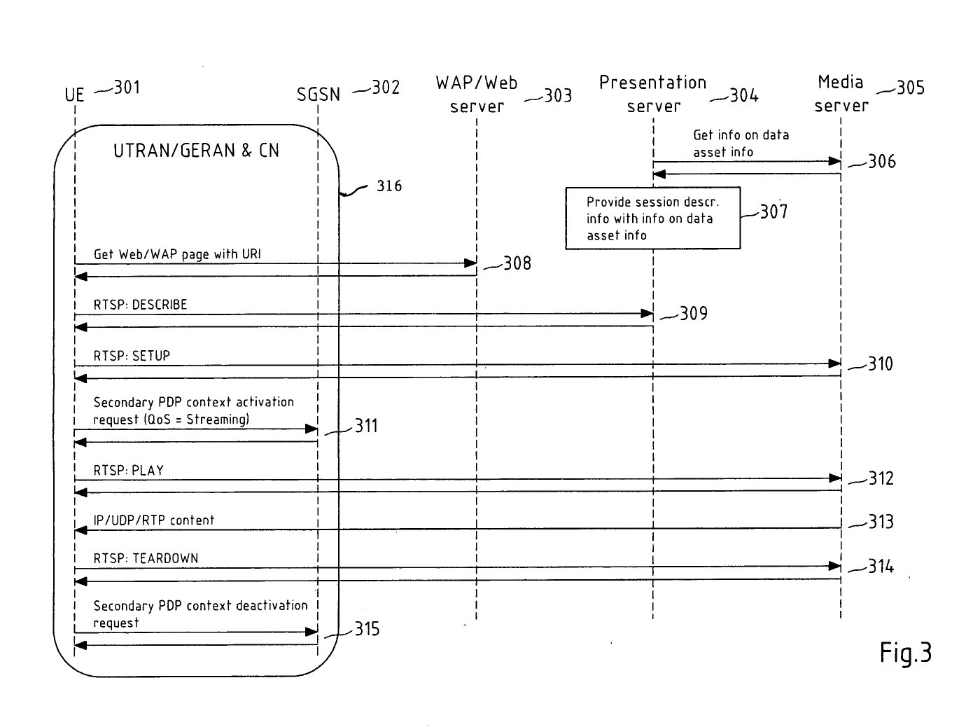

FIG. 3 depicts a schematic flowchart of the method according to the present invention. The flowchart indicates data and message transfer between a User Equipment (UE) 301, a Serving GPRS Support Node (SGSN) 302, a Wireless Application Protocol (WAP) or Web server 303, a presentation server 304, and a media or content server 305. Signalling within the Universal Mobile Telecommunications System (UMTS) Terrestrial Radio Access Network (UTRAN), Global System for Mobile Communications (GSM) or Enhanced Data Rates for GSM Evolution (EDGE) Radio Access Network (GERAN) and the Core Network (CN) is symbolised by the grey-shaded box of FIG. 3.

Data asset information that in this exemplary embodiment is jointly stored with actual data at the media server 305 according to a 3GP file format has to be made available to the presentation server 304. To this end, the asset data information is read from the 3GP file format at the media server 305 and then transferred to the presentation server 304 in a step 306. At the presentation server, which may for instance be an RTSP server, said data asset information is then used in a step 307 to set up session description information (an SDP file) according to an SDP that contains one or more attributes for the storage and/or referencing of asset information according to the present invention. Said SDP file may contain said data asset information or only a URL or any other kind of reference that indicates where said data asset information may be retrieved from. Alternatively, only a URL that identifies where said data asset information may be found may be transferred from said media server 305 to the presentation server 304 in said step 306, and then only said URL may be used to set up session description information.

If streaming content is to be viewed at the UE 301, the user of said UE 301 is first provided with a Universal Resource Identifier (URI) to specific content that suits his terminal in a step 308. This URI may come form a WWW or WAP server 303, or may have been entered manually via the keyboard of the UE 301. This URI specifies the presentation server 304. The corresponding SDP file, as set up in step 307, may now be obtained from the presentation server 304 in a step 309 via the RTSP DESCRIBE method. For the same purpose, the HTTP GET method could also be used.

Based on the data asset information contained or referenced in this SDP file, i.e. media-level information such as title, performers, keywords, URL locators of asset info, etc., the user of the UE 301 now may decide whether or not to start the transmission of the streaming content.

If a streaming transmission is desired, the subsequent session establishment step 310 is entered, in which the UE 301 invokes a streaming client to set up a session against the media server 305 via an RTSP SETUP method. This returns the UDP and/or TCP port to be used for the respective media stream, based on which a secondary Packet Data Protocol (PDP) context is requested by the UE 301 from the SGSN 302. Subsequently, the UE 301 sends an RTSP PLAY message 312 to the media server 305 that then starts to send one or more streams over the IP network in a step 313. Streaming is finished with an RTSP TEARDOWN method sent from the US 301 to the media server 305 in a step 314, causing a secondary PDP context deactivation request 315 from UE 301 to SGSN 302.

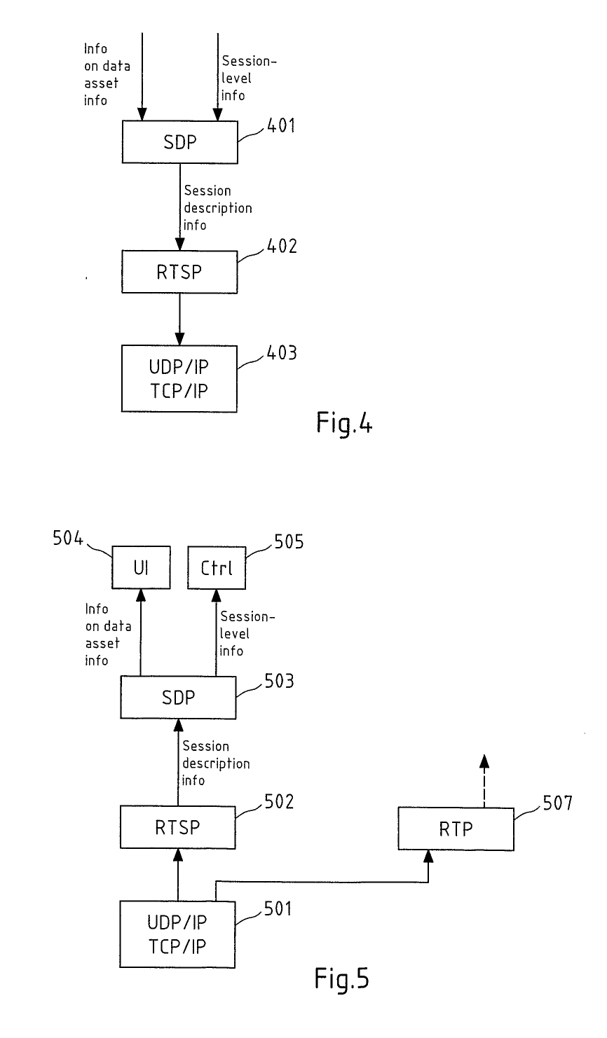

FIG. 4 depicts a schematic representation of the functional components of a first device according to the present invention. Said device may for instance be located in the presentation server 304 of FIG. 3. The device comprises an SDP instance 401, an RTSP instance 402 and an UDP/IP or TCP/IP instance 403. The SDP instance 401 receives data asset information or the URL locator of such information, for instance as provided by a media server after extracting the data asset information from a 3GP file format, and session-level information, for instance on the title of the session, the author of the session and the media format used in the session. According to the SDP, the SDP instance 401 then creates session description information, for instance an SDP file. In said session description information, said session-level information and said data asset information (or the location of the data asset information) may for instance be stored by means of pre-defined attributes. Said session description information is then forwarded from said SDP instance 401 to said RTSP instance 402, which exchanges said session description information with a peer RTSP entity located in a UE. Said exchange uses the services of either a UDP/IP or a TCP/IP, that is provided by the UDP/IP or TCP/IP instance 403.

FIG. 5 depicts a schematic representation of the functional components of a second device according to the present invention. Said device may for instance be located in the UE 301 of FIG. 3. Said device comprises an UDP/IP and/or TCP/IP instance 501, an RTSP instance 502, an SDP instance 503, a User Interface (UI) 504, a Control (Ctrl) instance 505 and an RTP instance 507. Session description information, e.g. an SDP file, is received via the RTSP instance 502 from a peer RTSP entity, which may for instance be located in the presentation server 304 of FIG. 3, based on the services of the UDP/IP or TCP/IP instance 501. Said session description information then is forwarded from said RTSP instance 502 to said SDP instance 503, wherein the data asset information (or the location of the data asset information) and session-level information is extracted from the SDP attribute fields. Said data asset information may then be displayed to a user of the UE 301 via said UI 504, so that the user may decide whether he wants to start the streaming session based on said data asset information. The session-level information may be further processed by said control instance 505, which may for instance check whether establishment of the session is possible on the UE 301 at all. Similarly, when the streaming transmission has been started within a transfer session, the actual data is received by said RTP instance 507 from a peer RTP entity at a media server 305 based on the services of said UDP/IP instance 501. Said data as output by said RTP instance 507 then may be further processed or rendered on said UE 301, as indicated by the dashed arrow in FIG. 5.

The invention has been described above by means of a preferred embodiment. It should be noted that there are alternative ways and variations which are obvious to a skilled person in the art and can be implemented without deviating from the scope and spirit of the appended claims, e.g. the different servers 303, 304 and 305 of FIG. 3 may be all or pairwise connected or represented by one and the same server. The temporal order of the steps of FIG. 1 is not mandatory. It may for instance be advantageous that a user of the UE 301 is enabled to receive data asset information when the streaming transmission has already begun, e.g. in order to get more information on an actor that is currently performing in the streaming media. Finally, the attribute structure of FIG. 2 is to be understood as only one possible way of defining an SDP attribute that contains data asset information or a link to data asset information.

1. A method for transferring data and information on associated data asset information, comprising
providing session description information that at least partially contains said information on said data asset information, wherein said session description information obeys a first protocol,
transferring said session description information to a destination instance based on a second protocol, and
transferring said data between a source instance and said destination instance within a transfer session and based on a third protocol.

2. The method according to claim 1, wherein at least at said source instance, said data and said information on said data asset information jointly obey a pre-defined format.

3. The method according to claim 1, wherein said data represents streamable content and wherein said transfer session is controlled by a Real-time Streaming Protocol RTSP.

4. The method according to claim 3, wherein said second protocol is said RTSP.

5. The method according to claim 3, wherein said RTSP uses the services of a Transport Control Protocol TCP, of a User Datagram Protocol UDP, or of a Hypertext Transfer Protocol HTTP.

6. The method according to claim 4, wherein said session description information is transferred to said destination instance by using a DESCRIBE method of said RTSP.

7. The method according to claim 1, wherein said data represents streamable content, and wherein said second protocol is a HTTP.

8. The method according to claim 7, wherein said HTTP uses the services of a TCP.

9. The method according to claim 1, wherein said data represents streamable content, and wherein said second protocol is a Real-time Transport Protocol RTP.

10. The method according to claim 1, wherein said third protocol is an RTP.

11. The method according to claim 9, wherein said RTP uses the services of a UDP.

12. The method according to claim 4, wherein said TCP or UDP uses the services of an Internet Protocol IP.

13. The method according to claim 1, wherein said first protocol is a Session Description Protocol (SDP).

14. The method according to claim 13, wherein said session description information is a data structure with at least one pre-defined attribute structure for at least a part of said data asset information or for at least one reference to an actual location of at least a part of said data asset information.

15. The method according to claim 1, wherein said second and third protocols at least partially define a protocol stack for a Packet-switched Streaming Service PSS in a 3G mobile communications system.

16. The method according to claim 2, wherein said pre-defined format is a 3GPP file format or any other file format.

17. The method according to claim 16, wherein said data asset information is asset meta-data information contained in a User Data Box of a Movie Box or Track Box of a 3GP file container or any other file container.

18. (canceled)

19. A computer program product comprising a computer program with instructions storable on a readable medium operable to cause a processor to perform the method of claim 1.

20. A system for transferring data and information on associated data asset information, the system comprising:
at least one source instance, and
at least one destination instance,
wherein session description information is provided that at least partially contains said information on said data asset information and that obeys a first protocol, wherein said session description information is transferred to said at least one destination instance based on a second protocol, and wherein said data is transferred between said at least one source instance and said at least one destination instance within a transfer session and based on a third protocol.

21. A device for transferring information on data asset information that is associated with data that is transferred between a source instance and a destination instance based on a first protocol, the device comprising:
a session description protocol for providing session description information that at least partially contains said information on said data asset information, wherein said session description information obeys a second protocol, and
a real-time streaming protocol and a user datagram protocol/internet protocol or transmission control protocol/internet protocol for transferring said session description information to a destination instance based on a third protocol.

22. A device for receiving data and information on associated data asset information, wherein session description information is provided that at least partially contains said information on said data asset information and that obeys a first protocol, the device comprising:
a user datagram protocol/internet protocol or a transmission control protocol/internet protocol for receiving said session description information, which is transferred to a destination instance based on a second protocol, and
a real-time transport protocol for receiving said data, which is transferred between a source instance and said destination instance within a transfer session and based on a third protocol.

23. The device according to claim 22, further comprising:
a session description protocol for at least partially extracting said information on said data asset information from said received session description information.

24. A session description protocol to be used in a system for transferring data and information on associated data asset information, wherein said data is transferred between a source instance and a destination instance within a transfer session and based on a first protocol, the session description protocol comprising:
a definition of a session description information that at least partially contains said information on said data asset information and that lends itself for transfer between said source instance and said destination instance based on a second protocol.
